(19) United States
(12) Patent Application Publication
(10) Pub. No.: US 2017/0161770 A1
(43) Pub. Date: Jun. 8, 2017

(54) UNIVERSAL LOYALTY REWARDS AND CURRENCY CONSOLIDATION

(71) Applicant: Universal Loyalty, Inc., Hazelwood, MO (US)

(72) Inventors: Samuel G. Toumayan, St. Louis, MO (US); John L. McMullin, III, St. Louis, MO (US); John E. Ebann, Fernandina Beach, FL (US); Ronald J. Raposa, Mesa, AZ (US); Jeffery L. Cates, O'Fallon, MO (US); Garrett D. Lehman, Arnold, MO (US); Steve A. Litzau, Kirkwood, MO (US)

(21) Appl. No.: 15/441,708

(22) Filed: Feb. 24, 2017

Related U.S. Application Data
(63) Continuation of application No. 14/199,303, filed on Mar. 6, 2014.
(60) Provisional application No. 61/792,033, filed on Mar. 15, 2013.

(51) Int. Cl. G06Q 30/02; G06Q 20/20

(52) U.S. Cl. CPC G06Q 30/0229; G06Q 20/202; G06Q 30/0227; G06Q 30/0238

(57) ABSTRACT

A system and method for providing a universal loyalty rewards and currency consolidation program is disclosed. The system allows customers to make purchases and earn rewards from a plurality of participant merchants using multiple payment forms, and at the same time, allows customers to redeem rewards at both participant and non-participant merchants.

The system may be implemented in both physical retail environments and online shopping environments.

### CROSS REFERENCE TO RELATED APPLICATIONS

This application is a Continuation of U.S. patent application Ser. No. 14/199,303, filed Mar. 6, 2014 which claims the benefit of U.S. Provisional Patent Application No. 61/792,033 filed Mar. 15, 2013, which is hereby incorporated by reference.

### TECHNICAL FIELD OF THE DISCLOSURE

The present disclosure relates to electronic commerce and, more specifically, to systems and methods for providing a universal loyalty rewards and currency consolidation program.

### BACKGROUND

Customers are frequently solicited by merchants, manufacturers, and payment providers to join an individually sponsored loyalty program. Customers are often reluctant to join such programs due to the need to maintain separate accounts or carry a separate card or device for each individual loyalty program. Customers may also feel that they don't make enough purchases at a particular retailer to justify their involvement in that retailer's loyalty program.

Other types of loyalty programs have developed which allow customers to make purchases at multiple retailers or vendors. However, these programs contain other limitations which discourage participation by customers. For example, the programs often require that the customer use a single form of payment, such as a particular credit card account, when making purchases in order to earn rewards on those purchases. The programs may also require that any redemption of earned rewards be made at a single merchant or limited group of merchants, thereby limiting the choice of products or locations available to the customer. This creates inconvenience to customers and further discourages them from participating in the program. Therefore, improvements are needed in this field.

### SUMMARY

According to one aspect, a method for administering a loyalty rewards program for a plurality of customers and merchants is disclosed, comprising receiving, using a loyalty server computer, a request to create a loyalty account for a first customer; creating, using the loyalty server computer, a loyalty reward account and associated customer identifier corresponding to the first customer; providing to the customer a loyalty device associated with the loyalty account, wherein the customer identifier is stored within the loyalty device; receiving, using the loyalty server computer, a first purchase information from a first merchant point of sale computer, the first purchase information comprising a purchase price, the customer identifier, and a merchant identifier, wherein the first merchant accepts any one of a plurality of payment forms from the customer to pay for the first purchase; increasing, using the loyalty server computer, a point balance of the loyalty account based on the purchase price of the first purchase if the first merchant is a participant in the loyalty rewards program; receiving, using the loyalty server computer, second purchase information from a second merchant point of sale computer to redeem at least a portion of the point balance toward a second purchase being made by the customer, said second purchase information comprising a second purchase price, the customer identifier, and a second merchant identifier; reducing, using the loyalty server computer, the point balance of the loyalty account based on the second purchase; and transmitting, using the loyalty server computer, a confirmation to the second merchant point of sale computer that the loyalty account has a sufficient balance to pay for the second purchase; wherein said reducing and transmitting stages are performed if the second merchant is a participant in the loyalty rewards program; and wherein said reducing and transmitting stages are performed if the second merchant is not a participant in the loyalty rewards program.

According to another aspect, a system for providing universal loyalty rewards to a customer is disclosed, comprising a loyalty server configured to receive purchase information for purchases made by the customer at multiple merchants, said purchase information comprising a customer identifier associated with a customer loyalty account maintained on the loyalty server.

The loyalty server is further configured to increase a point balance in the loyalty reward account associated with the customer for each purchase made at a merchant participating in the loyalty rewards program, wherein the merchant accepts multiple forms of payment from the customer for the purchase; and transfer at least a portion of the points to be available for use toward purchases at both the participating merchants and non-participating merchants when requested by a customer computer. The system may be further configured to load said transferred points into a prepaid access card account associated with a prepaid access card assigned to the customer, said prepaid access card being accepted at both participating merchants and non-participating merchants.

According to another aspect, a system for providing universal loyalty rewards to a customer is disclosed, comprising: a merchant server for providing an online shopping interface; a loyalty server for administering the loyalty rewards program; and a loyalty API loaded on said merchant server and in communication with said online shopping interface, said loyalty API being configured to communicate with said loyalty server; wherein said loyalty API transmits purchase information to said loyalty server, said purchase information related to a purchase made by the customer using the online shopping interface; wherein the loyalty server adds points to the customer's loyalty account based on the purchase information; and wherein, upon request of a customer computer, the loyalty servers is configured to transfer at least a portion of the points to be available for use toward purchases at both participating merchants and non-participating merchants when requested by a customer computer.

### BRIEF DESCRIPTION OF THE DRAWINGS

FIG. 1 is a schematic block diagram of a system for providing a universal loyalty rewards and currency consolidation program according to one embodiment of the present disclosure.

FIG. 2 is a schematic flow diagram of a method for providing a universal loyalty rewards and currency consolidation program according to one embodiment of the present disclosure.

FIG. 3 is a schematic flow diagram of a method for providing a universal loyalty rewards and currency consolidation program according to another embodiment of the present disclosure.

FIG. 4 is a schematic flow diagram of a method for providing a universal loyalty rewards and currency consolidation program according to another embodiment of the present disclosure.

FIG. 5 is a schematic flow diagram of a method for providing a universal loyalty rewards and currency consolidation program according to another embodiment of the present disclosure.

### DETAILED DESCRIPTION OF THE PREFERRED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

The present disclosure relates to a system and method for providing loyalty rewards to customers using a universal platform for all loyalty reward sponsors. The reward sponsors are typically merchants, manufacturers, or resellers who have a physical retail location and/or an online store, and who have agreed to participate in the loyalty rewards program. The system is configured to allow customers to earn loyalty rewards based on purchases made at any of the participating reward sponsors and to pay for those purchases using any form of payment accepted by the particular merchant or reward sponsor, including, but no limited to, cash, check, credit card, debit card, and the like. In other words, the customer is not required to pay for the purchases using a single form of payment, or even a single financial account. Once the customer has accumulated points in their loyalty account based on prior purchases, the customer can transfer all or a portion of the points to a loyalty device or separate prepaid account, which may be used to make purchases at any of the participating reward sponsors or at other non-participating merchants which are not reward sponsors. In order to facilitate redemption purchases at non-member or non-participating merchants, the loyalty device may comprise a payment device which most merchants accept, such as a credit card or prepaid access card. This provides maximum convenience to the customer with regard to both flexibility of payment in making purchases to earn rewards and flexibility in choosing merchants to redeem the rewards. In certain embodiments, the participating merchants are not charged any administration fees for participation in the program. Rather the merchants' only cost is the value of the points that are earned by the customers for the purchases.

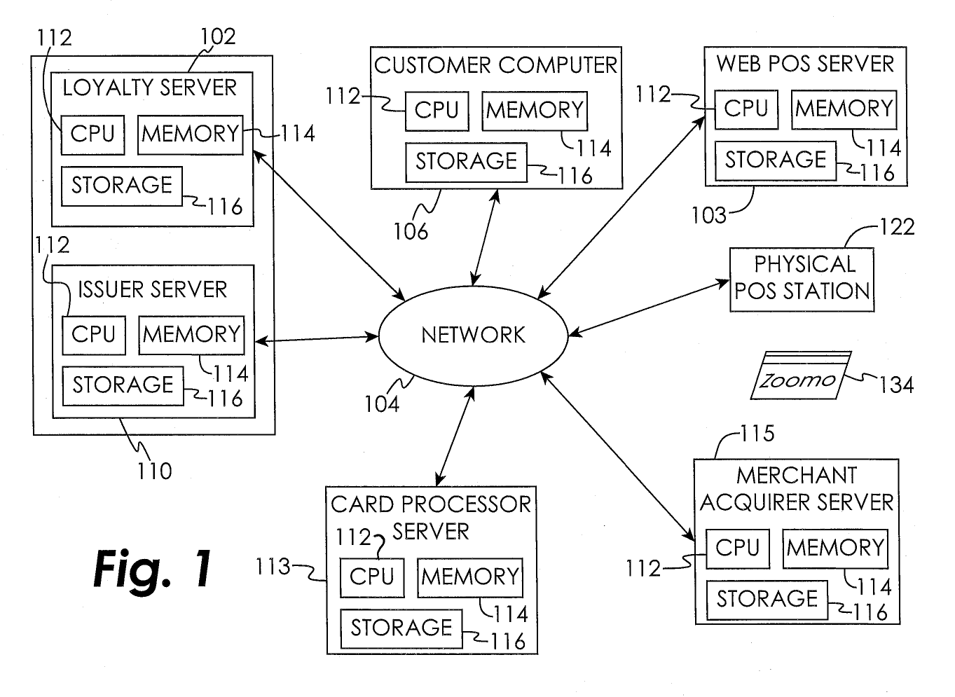

FIG. 1 shows a schematic block diagram of a system according to one embodiment of the present disclosure. System 100 includes a loyalty web server 102, merchant point-of-sale (POS) web server 103, merchant POS physical retail station 122, network 104, and customer computer 106. In addition, issuer server 110, financial processor server 113, and merchant acquirer server 115 may also be included. The POS station 122 is located at a physical retailer's location, while the customer computer 106 is located at the customer's home or other preferred location. The servers 102, 103, 110, 113, and 115 are typically located remotely from both the POS station 122 and customer computer 106.

Servers 102, 103, 110, 113, and 115, POS station 122, and customer computer 106 are able to communicate via network 104. Network 104 may comprise a Local Area Network (LAN), a Wide Area Network (WAN), the internet, or combinations thereof. In addition, network 104 may optionally incorporate wireless communications equipment and methods to facilitate communication between the servers 102, 103, 110, 113, and 115, POS station 122, and customer computer 106.

The POS physical retail station 122 includes a POS input terminal, such as a credit card reader or cash register, which is able to communicate with or read data from a hand-held loyalty device 134, which is issued to the customer as will be illustrated further below.

The hand-held loyalty device 134 is issued to a customer (i.e. a consumer) and is configured to communicate with the POS retail station 122. Specifically, the loyalty device 134 is capable of storing the information needed to identify the customer loyalty account, for example, a customer loyalty account number or other customer identifier. The POS physical retail station 122 is likewise configured to communicate with the loyalty device 134 using electromagnetic scan, Near Field Communication (NFC), Bluetooth, USB direct contact, or other wired or wireless communication formats known in the art. The loyalty device 134 may be implemented as a magnetic stripe card, a smart card, flash drive, key fob, or the like. The member loyalty device may also comprise a memory storage device for storing the customer account identifier and/or other information needed to identify the customer loyalty account.

In certain embodiments, the functionality of the loyalty device 134 may be included in or added to a personal mobile device, such as a mobile phone with the ability to the communicate over the medium or protocol being used by the POS physical retail station 122. The personal mobile device may further include the ability to function as a website interface and transmit the customer identifier directly to the loyalty web server 102 over network 104 when a purchase or redemption is being made by the customer through an online merchant or shopping interface.

The loyalty server 102 includes computer readable code for administering and maintaining the universal loyalty rewards program and tracking the individual point balances for each customer and is in communication with the merchant web server 103 and the customer computer 106. The loyalty server 102 may also be in communication with the merchant POS physical retail station 122, either directly or via servers 110, 113, and 115.

The merchant web server 103 includes computer readable code for maintaining the merchant's online shopping interface, such as an ecommerce website or online shopping cart. In certain embodiments, a loyalty application programming interface (API) will be provided to the merchant and added to the merchant's own shopping cart software. The loyalty API may be written and configured to conform to the programming language or operating system environment being implemented on the merchant web server 103.

The servers 102, 103, 110, 113 and 115 may be implemented on a rack-mountable or blade server, a personal computer, a workstation computer, a laptop computer, a palmtop computer, or the like. It will be apparent to those of ordinary skill in the art that other computer system architectures may also be employed.

In general, the servers 102, 103, 110, 113 and 115 comprise a bus for communicating information, a processor 112 coupled with the bus for processing information and a memory 114 coupled to the bus for storing information and instructions for the processor 112. A mass storage interface for communicating with a data storage device 116 containing digital information may also be included in the servers 102, 103, 110, 113 and 115 as well as a network interface for communicating with the network 104.

The processors 112 may be any of a wide variety of general purpose processors or microprocessors such as the PENTIUM microprocessor manufactured by INTEL Corporation, a POWER PC manufactured by IBM Corporation, a SPARC processor manufactured by Sun Corporation, or the like. It will be apparent to those of ordinary skill in the art, however, that other varieties of processors may also be used in a particular computer system.

The memory 114 may include one or more types of solid-state electronic memory, magnetic memory, or optical memory, just to name a few. By way of non-limiting example, memory 114 may include solid-state electronic Random Access Memory (RAM), Sequentially Accessible Memory (SAM) (such as the First-In-First-Out (FIFO) variety or the Last-In-First-Out (LIFO) variety), Programmable Read Only Memory (PROM), Electronically Programmable

Read Only Memory (EPROM), or Electrically Erasable Programmable Read Only Memory (EEPROM). Also, memory 114 may be volatile, nonvolatile, or a hybrid combination of volatile and nonvolatile varieties.

The mass storage interface may allow the processors 112 access to the digital information contained within the digital storage devices 116 via the bus. The mass storage interface may be a universal serial bus (USB) interface, an integrated drive electronics (IDE) interface, a serial advanced technology attachment (SATA) interface or the like, coupled to the bus for transferring information and instructions. The data storage device 116 may be a conventional hard disk drive, a floppy disk drive, a flash device (such as a jump drive or SD card), an optical drive such as a compact disc (CD) drive, digital versatile disc (DVD) drive, HD DVD drive BLU-RAY disc drive, or another magnetic, solid state, or optical data storage device, along with the associated medium (a floppy disk, a CD-ROM, a DVD, etc).

It shall be understood that the processors 112 may be comprised of one or more components configured as a single unit. Alternatively, when in multi-component form, a processor 112 may have one or more components located remotely relative to the others. One or more components of each processor 112 may be of the electronic variety defining digital circuitry, analog circuitry, or both.

Customer computer 106 may be implemented using any of the computer architectures described above in relation to web servers 102 and 103. Customer computer 106 may further be implemented using a wireless mobile electronic device having computing capabilities, such as a mobile phone having a Windows CE™ or Palm™ operating system, a Blackberry™, an iPhone™ or the like. Customer computer 106 may also comprise a processor 112, memory 114, mass storage interface, bus, network interface and storage devices 116 as described hereinabove in relation to servers 102, 103, 110, 113, and 115.

In general, the processor 112 retrieves processing instructions and data from the data storage device 116 using the mass storage interface and downloads this information into random access memory for execution. The processor 112 then executes an instruction stream from random access memory or read-only memory. Command selections and information that is input using input devices such as keyboards, mice, and the like are used to direct the flow of instructions executed by the processor 112. The results of this processing execution are then displayed on an electronic computer display operatively coupled to the processor 112.

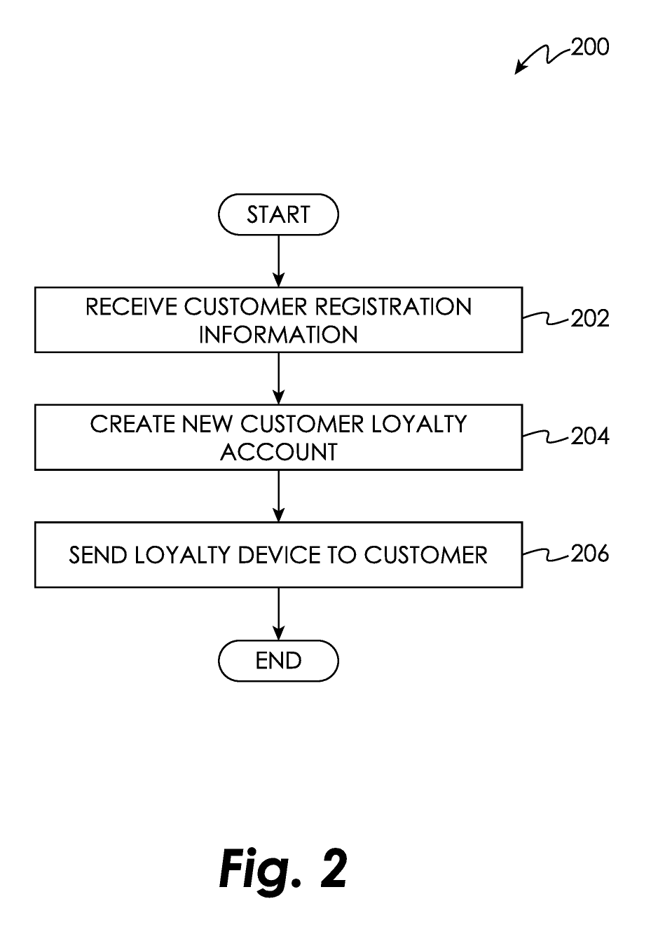

FIG. 2 illustrates a process 200 for registering a customer in a universal loyalty rewards program according to one embodiment of the present disclosure. The process begins at stage 202 when the customer completes an online form provided in an online website interface using computer 106 and transmits the registration form to the loyalty server 102 via network 104. The customer may also fill out a paper form and send it to the loyalty program administrator for processing.

At stage 204, the loyalty server receives the new customer registration information. After performing any necessary credit checks or other needed verification, the loyalty server creates and stores a loyalty account and an associated account or customer identifier.

At stage 206, a loyalty device 134 is produced and supplied to the customer. The loyalty device 134 contains a customer or account identifier which can be used by the loyalty server 102 to identify and process transactions being transmitted to the loyalty server 102. The loyalty device 134 may further be supplied as a branded credit or debit card, such as Mastercard, Visa, Discover, or the like, thereby allowing the loyalty device 134 to be accepted at most merchants. In certain embodiments, instead of supplying the customer with a physical card, the account identifier may be electronically transmitted to the customer computer 106 or personal computing device (e.g., smart phone), with the personal computing device thereafter serving as the loyalty device.

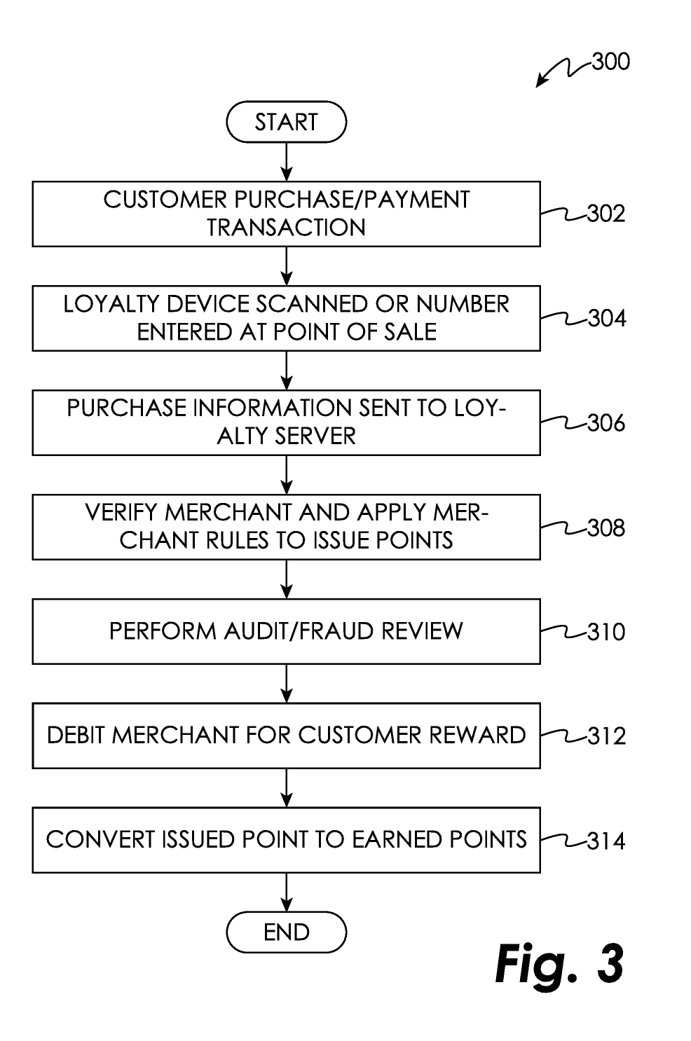

FIG. 3 illustrates a process 300 for the customer to purchase products and thereby earn loyalty rewards in the program. The process begins at stage 302 when the customer makes a purchase at participating program merchant and pays for the purchase using any one of multiple forms of payment accepted by the merchant. For example, the customer may pay for the purchase by cash, credit card, check, or other form of payment. The purchase may be made at either a brick and mortar retail POS (such as POS station 122), or via an online shopping website (by using computer 106 to interact with an online shopping interface supplied by web server 103).

At stage 304, the customer provides the loyalty device 134 to the cashier at POS station 122 for scanning (or in the case of the online shopping interface supplied by web server 103, by entering the customer identifier shown on the loyalty device 134).

At stage 306, the purchase information, including the purchase price, a merchant identifier, and customer identifier are transmitted to the loyalty server 102. Additional information regarding the purchase may also be transmitted to the loyalty server 102, such as the type, brand or model of the product, and/or the date/time of the transaction. The purchase information may be sent directly from the POS station 122 or web server 103 to the loyalty server 102, or may be sent through one or more financial intermediaries. In one common scenario, the purchase information is sent from the POS station 122 to merchant acquirer server 115, then to processing server 113 (e.g., Mastercard), then to the loyalty program issuer bank server 110, and finally to loyalty server 102. It shall be understood that any of the financial intermediary servers 110, 113, and 115 may be combined or integrated depending on the needs of the particular program.

At stage 308, the loyalty server 102 receives the purchase information and locates the corresponding customer loyalty account and verifies the account validity. The loyalty server 102 also verifies that the merchant (based on the merchant identifier) is a participant in the loyalty program. The loyalty server 102 then applies rules to determine the amount of reward points that should be issued to the customer account as a result of the purchase. The rules may be customized based on various criteria, such as the identity of the participating merchant or the date/time of the purchase. For example, the customer may receive a certain percentage of the purchase price as reward points for purchases made at a first participating merchant, and a different percentage of the purchase price as reward points for purchases made at a second participating merchant. As another example, the customer may receive a larger percentage of reward points for larger purchase amounts (e.g., over a certain dollar amount), and a smaller percentage of reward points for smaller purchase amounts.

In certain embodiments, rewards may be given for other non-purchase activities or behaviors, such attending promotional events, traveling to certain locations (e.g., a particular shopping mall), or the like. Adjustments to the available promotions or special rewards may also be done dynamically in real time, such as to sell more of a certain product in the afternoon if morning sales were slower than normal. Customers may also receive notifications, electronic or otherwise, of various promotions or incentives, both periodically and in real time.

In certain embodiments, customers may also transfer their reward points to other customers as a gift or sale. Customers may also have multiple reward accounts (e.g., for members of the same family), and may consolidate points from multiple accounts to a single card or account for easier redemption.

At stage 310, the loyalty server performs an audit or fraud review based on various criteria relating to the purchase and/or customer behavior.

At stage 312, the loyalty server will debit, invoice, or otherwise request payment from the merchant for the amount of the rewards points that were awarded to the customer based on the purchase. In this way, the participating merchants fund the rewards being supplied to the customers. In certain embodiments, the loyalty server 102 deducts a portion of the amount received from the merchant to pay the loyalty program administrator, with the remaining amount serving as the reward amount to the customer. Other variations on the funding formula and logic may also be used. The merchant deduction may be done in real time for each transaction or may be consolidated and completed at certain intervals (e.g., nightly).

At stage 314, after the fraud check and merchant debit have been completed, the calculated reward points which will be credited to the customer are converted from an “issued” status to an “earned” status.

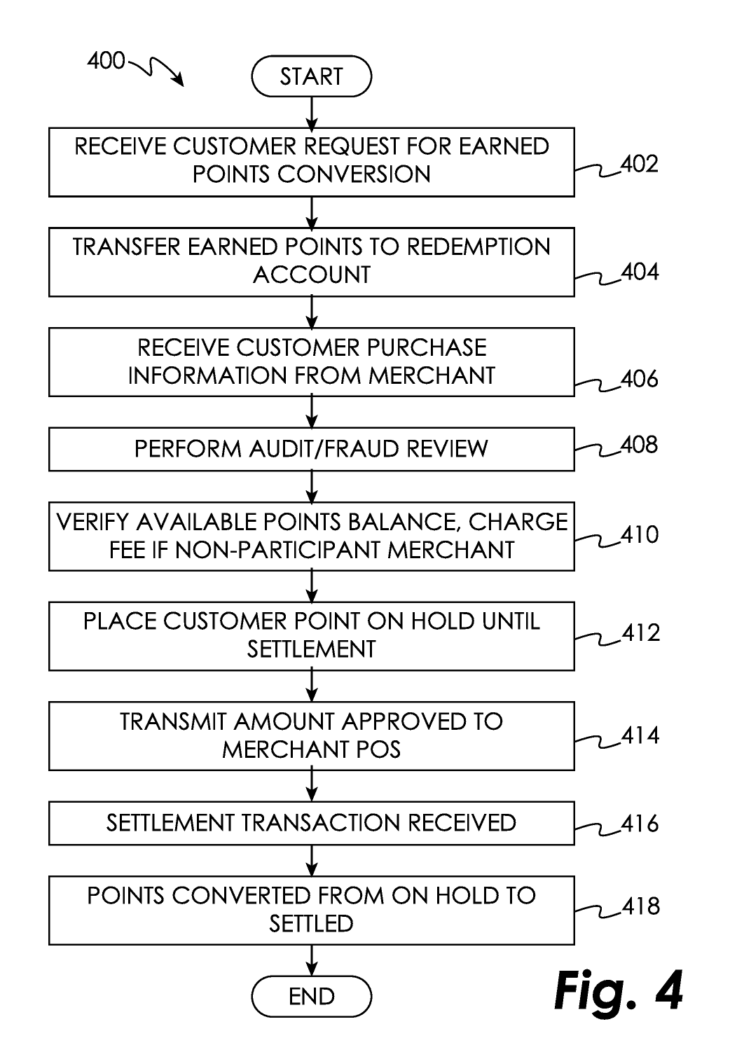

FIG. 4 illustrates a process 400 for redeeming customer rewards after they have been earned. The process starts at stage 402, when the customer connects to the loyalty server 102 using, for example, computer 106, and requests that at least a portion of the earned reward points be made available for spending. In a preferred embodiment, the customer is provided an interface, such as a website, that displays the account point balance, whereby the customer can view and request at least a portion of the points to be made available for redemption. Various promotions and incentives may be applied to encourage or discourage the customer to spend the available points, and/or visit particular merchants for purchases. In certain embodiments, a waiting period or delay may be imposed before the customer can redeem earned points. The waiting period or delay may be varied on certain factors, such as the identity of the merchant where the points are to be used.

At stage 404, the loyalty server 102 transfers the amount of requested points to a separate account or card for use in redemption. The separate account or card may also be branded with a commonly accepted credit association or provided, such as MasterCard, Visa, or the like. In one embodiment, the requested points are transferred to a prepaid card account, which may also be associated with the loyalty device 134 and/or customer identifier. The customer is then free to make purchases using the loyalty device 134 or other associated card at both participating loyalty program merchants and non-participating merchants. The customer may also request a cash payment in exchange for the points being converted. In this case, the amount of cash may be less in value than if the customer chooses to redeem points at a participating merchant.

At stage 406, the customer makes a purchase using the loyalty device 134 (or other separate account or card) in order to redeem the available points. The merchant scans the loyalty device 134, and transmits the purchase information (including the account identifier and merchant identifier) to the loyalty server 102. Again, the purchase information may be transmitted directly to the loyalty server 102, or through one or more of the financial intermediary servers, 110, 113, and/or 115. At stage 408, the loyalty server 102 performs an audit or fraud review similar to stage 310 above.

At stage 410, the loyalty server 102 inspects the merchant identifier and determines whether the merchant is a participant in the loyalty program. If the merchant is a participant, the loyalty server 102 determines whether there is a sufficient available point balance to pay for the purchase. If there is a sufficient balance, a confirmation will be sent to the merchant POS station 122 or server 103 and the needed amount of points is deducted from the customer's available point balance. Also, if the merchant is a participant, additional rewards may be earned based on the transaction. If the merchant is not a participant in the loyalty program, the available point balance may be used to pay for the transaction, however, an “out of network” fee may be optionally charged to the customer's account as part of the redemption and the customer will not earn points on the transaction. Also, if the redemption is being made at a participating merchant, the amount of points that must be redeemed for a given purchase may be less than the amount required at nonparticipating merchants. This encourages customers to make redemptions at participant merchants, while still providing the flexibility of being able to redeem at non-participant merchants when needed.

At stage 412, the points being redeemed are placed “on hold” until a settlement transaction is received, if the settlement is being handled in a batch or delayed fashion. In certain embodiments, the settlement may happen instantaneously, as opposed to delay until a later time.

At stage 414, a confirmation is sent back to the merchant POS station 122 or server 103 with confirmation (or rejection) of the payment for the transaction. The confirmation may optionally be sent through financial intermediary servers 110, 113, and/or 115 before reaching loyalty server 102 as discussed above.

At stage 416, the settlement transaction is received from the merchant POS station 122 or server 103, or from one of the financial intermediary servers 110, 113 or 115, at which point any points in “on hold” status are converted to “settled” at stage 418 and deleted from the customer loyalty account. If a customer later returns a purchased product, then any bonuses or increased earning incentives used to make the purchase may be revoked or recaptured from the customer's loyalty account when the return is made.

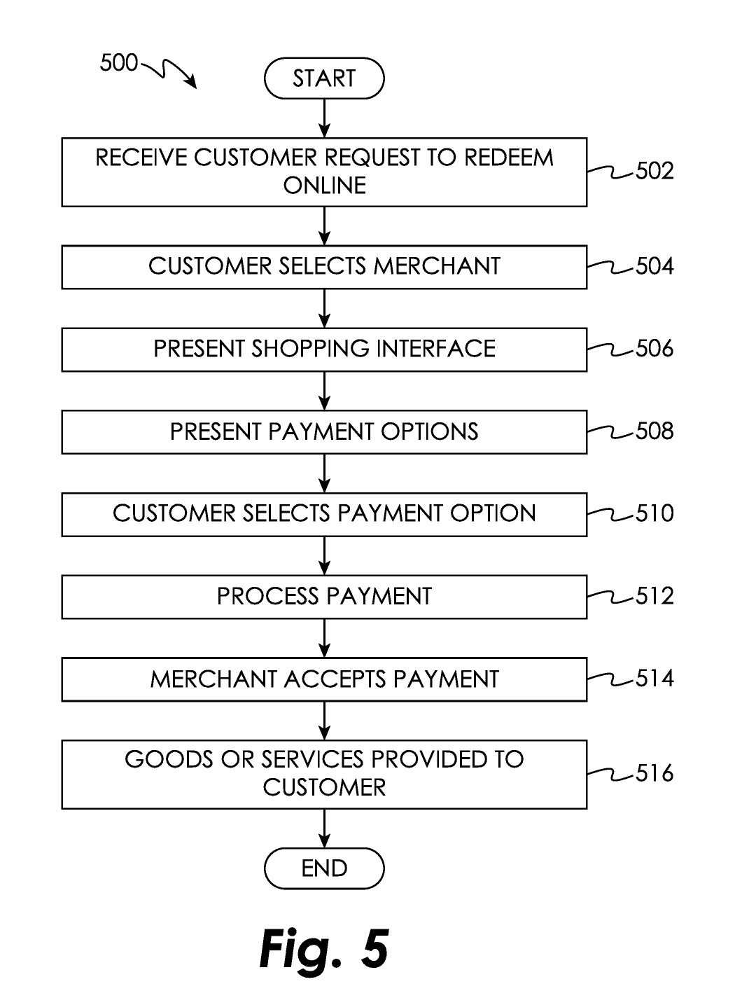

FIG. 5 illustrates a process 500 for online reward redemption according to one embodiment. The process begins at stage 502, when the customer connects to the loyalty server 102 using, for example, computer 106, and is provided with an interface, such as a website, whereby the customer can select various redemption options. As one option, the customer may select a particular merchant using the interface (stage 504), after which the browser of the customer computer 106 is automatically directed or referred to the merchant website. As part of the referral, the customer information (reward account number, special reward information etc.) is sent with the request. The customer may also be given the option to purchase products directly from the loyalty server interface, such as for products that have been sourced and are being sold directly by the loyalty program administrator.

At stage 506, the customer reviews the available products on the merchant website (hosted on web server 103 or directly on the loyalty server 102) and selects a product to purchase using reward points. At stage 508, the customer is presented with various payment options. At step 510, the customer selects a payment option. If the customer has enough available points to purchase the selected product(s), the customer can select “loyalty rewards” as the payment option. If the customer does not have enough available points, they can choose to pay for a portion of the purchase price with their reward points and the remaining portion by another payment option, such as credit card, debit card, and the like. At stage 512, the customer's payment is processed. If the customer is paying for the purchase by credit card, the payment is processed as described above with respect to stage 406. However, if the customer uses only reward points, or other non-credit card payment, the payment can be processed directly by an application programming interface (API) within the merchant website which communicates directly with the loyalty server 102 to settle the transaction, and thereby avoiding costly processing fees which are typically imposed on merchants for credit card, debit card, prepaid access card, or other similar purchases.

Once the merchant computer (server 103) receives confirmation from the loyalty server 102 (or intermediary server 110, 113, or 115), the merchant interface completes the transaction with the customer (stage 514), and the goods or services are provided to the customer (stage 516).

In addition to redeeming rewards at participant merchant physical locations and merchant online shopping systems, a consolidated portal may be provided as part of the loyalty program and implemented optionally on loyalty server 102. The consolidated portal may provide a single interface through which the customer can purchase to earn and/or redeem points from participating merchants.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method for administering a loyalty rewards program for a plurality of customers and merchants, comprising:
receiving, using a loyalty server computer, a request to create a loyalty account for a first customer;
creating, using the loyalty server computer, a loyalty reward account and associated customer identifier corresponding to the first customer;
providing to the customer a loyalty device associated with the loyalty account, wherein the customer identifier is stored within the loyalty device;
receiving, using the loyalty server computer, a first purchase information from a first merchant point of sale computer, the first purchase information comprising a purchase price, the customer identifier, and a merchant identifier, wherein the first merchant accepts any one of a plurality of payment forms from the customer to pay for the first purchase;
increasing, using the loyalty server computer, a point balance of the loyalty account based on the purchase price of the first purchase if the first merchant is a participant in the loyalty rewards program;
receiving, using the loyalty server computer, second purchase information from a second merchant point of sale computer to redeem at least a portion of the point balance toward a second purchase being made by the customer, said second purchase information comprising a second purchase price, the customer identifier, and a second merchant identifier;
reducing, using the loyalty server computer, the point balance of the loyalty account based on the second purchase; and
transmitting, using the loyalty server computer, a confirmation to the second merchant point of sale computer that the loyalty account has a sufficient balance to pay for the second purchase;
wherein said reducing and transmitting stages are performed if the second merchant is a participant in the loyalty rewards program; and
wherein said reducing and transmitting stages are performed if the second merchant is not a participant in the loyalty rewards program.

2. The method of claim 1, wherein said increasing stage comprises increasing the point balance of the loyalty account by a percentage of the first purchase price if the first merchant is a participant in the loyalty rewards program.

3. The method of claim 1, wherein said increasing stage comprises:
increasing the point balance of the loyalty account based on a first formula if the first purchase is made at a first merchant; and
increasing the point balance of the loyalty account based on a second formula if the first purchase is made at a second merchant.

4. The method of claim 3, wherein said increasing stage comprises:
increasing the point balance of the loyalty account by a first percentage of the first purchase price if the first purchase is made at a first merchant; and
increasing the point balance of the loyalty account by a second percentage if the first purchase is made at a second merchant.

5. The method of claim 3, wherein said increasing stage comprises:
increasing the point balance of the loyalty account based on a first formula if the first purchase is made during a first date range; and
increasing the point balance of the loyalty account based on a second formula if the first purchase is made during a second date range.

6. The method of claim 1, further comprising:
receiving, from a customer computer, a request to make at least a portion of said point balance available for redemption toward future purchases; and
transferring, using the loyalty server, said portion of said point balance to a prepaid access card account, said prepaid access card account associated with said loyalty device.

7. The method of claim 1, wherein the merchant point of sale computer is located within a physical retail location.

8. The method of claim 1, wherein the merchant point of sale computer comprises a web server and said first purchase is made using an online shopping interface.

9. The method of claim 1, wherein said loyalty device comprises a magnetic stripe card.

10. The method of claim 1, wherein said loyalty device comprises a keyfob device.

11. The method of claim 1, wherein said loyalty device comprises an electronically stored information packet on a personal mobile device.

12. The method of claim 11, wherein said personal mobile device comprises a mobile phone.

13. A system for providing universal loyalty rewards to a customer, comprising:
a loyalty server configured to:
receive purchase information for purchases made by the customer at multiple merchants, said purchase information comprising a customer identifier associated with a customer loyalty account maintained on the loyalty server;
increase a point balance in the loyalty reward account associated with the customer for purchases made at a merchant participating in the loyalty rewards program, wherein the merchant accepts multiple forms of payment from the customer for the purchase; and
transfer at least a portion of the points to be available for use toward purchases at both the participating merchants and non-participating merchants when requested by a customer computer.

14. The system of claim 13, wherein the server is further configured to load said transferred points into a prepaid access card account associated with a prepaid access card assigned to the customer, said prepaid access card being accepted at both participating merchants and non-participating merchants.

15. The system of claim 13, wherein the loyalty server is configured to increase the point balance of the loyalty account by a percentage of a first purchase price if the first merchant is a participant in the loyalty rewards program.

16. The system of claim 13,
wherein the loyalty server is configured to increase the point balance of the loyalty account based on a first formula if a first purchase is made at a first merchant; and
wherein the loyalty server is configured to increase the point balance of the loyalty account based on a second formula if the first purchase is made at a second merchant.

17. The system of claim 13, wherein the loyalty server is configured to:
increase the point balance of the loyalty account by a first percentage of a first purchase price if the first purchase is made at a first merchant; and
increase the point balance of the loyalty account by a second percentage if the first purchase is made at a second merchant.

18. The method of claim 13, wherein the loyalty server is configured to:
increase the point balance of the loyalty account based on a first formula if the first purchase is made during a first date range; and
increase the point balance of the loyalty account based on a second formula if the first purchase is made during a second date range.

19. The system of claim 13, wherein the loyalty server is further configured to:
receive, from a customer computer, a request to make at least a portion of said point balance available for redemption toward future purchases; and
transfer said portion of said point balance to a prepaid access card account, said prepaid access card account associated with said loyalty account.

20. A system for providing universal loyalty rewards to a customer, comprising:
a merchant server for providing an online shopping interface;
a loyalty server for administering the loyalty rewards program; and
a loyalty API loaded on said merchant server and in communication with said online shopping interface, said loyalty API being configured to communicate with said loyalty server;
wherein said loyalty API transmits purchase information to said loyalty server, said purchase information related to a purchase made by the customer using the online shopping interface;
wherein the loyalty server adds points to the customer's loyalty account based on the purchase information; and
wherein, upon request of a customer computer, the loyalty server is configured to transfer at least a portion of the points to be available for use toward purchases at both participating merchants and non-participating merchants when requested by a customer computer.
